(19) United States
(12) Patent Application Publication
(10) Pub. No.: US 2016/0313450 A1
(43) Pub. Date: Oct. 27, 2016

(54) AUTOMOTIVE GNSS REAL TIME KINEMATIC DEAD RECKONING RECEIVER

(71) Applicant: Autoliv ASP, Inc., Ogden, UT (US)

(72) Inventors: David F. Jordan, Danville, NH (US); Darryl A. Groom, Hudson, NH (US)

(21) Appl. No.: 14/696,713

(22) Filed: Apr. 27, 2015

(51) Int. Cl. G01S 19/40

(52) U.S. Cl. CPC G01S 19/40

(57) ABSTRACT

An apparatus comprising a first antenna, a second antenna, a processor and a memory. The first antenna may be configured to connect to a GPS satellite. The second antenna may be configured to connect to the GPS satellite. The first antenna is positioned separately from the second antenna. The processor may be configured to execute instructions. The memory may be configured to store the instructions that, when executed, perform the steps of (i) calculating a first value measured through a connection between the first antenna and the GPS satellite, (ii) calculating a second value measured through a connection between the second antenna and the GPS satellite, and (iii) determining a correction value to compensate for local conditions by analyzing differences between the first value and the second value.

### FIELD OF THE INVENTION

The present invention relates to global positioning systems (GPS) generally and, more particularly, to a method and/or apparatus for implementing an automotive GNSS real time kinematic dead reckoning receiver.

### BACKGROUND OF THE INVENTION

Conventional GPS systems commonly use real-time kinematics (RTK) to provide fixed land-based reference stations. Conventional systems use expensive sensors to improve accuracy of standard GPS. Such systems are useful for providing centimeter level accuracy in agriculture applications and land survey applications. Conventional automotive Global Navigational Satellite System (GNSS) receivers employ position solutions with sensor-based dead reckoning using on-board gyroscope and wheel click messages from a vehicle controller area network (CAN) to maintain up to 5 meter accuracy in open sky conditions. The accuracy is worse in dense foliage and urban areas. Vehicle sensors are inaccurate, have drift and depend on latency of the dead reckoning (DR) technique accessing data from the CAN. Next-generation automotive position solutions will likely need greater accuracy (a more precise GNSS position solution) in order to safely detect lanes and/or to support autonomous driving. Conventional systems do not support the accuracy needed for safe and widespread use of next-generation automotive positioning systems.

It would be desirable to implement an automotive GNSS real time kinematic dead reckoning receiver.

### SUMMARY OF THE INVENTION

The present invention concerns an apparatus comprising a first antenna, a second antenna, a processor and a memory. The first antenna may be configured to connect to a GPS satellite. The second antenna may be configured to connect to the GPS satellite. The first antenna is positioned separately from the second antenna. The processor may be configured to execute instructions. The memory may be configured to store the instructions that, when executed, perform the steps of (i) calculating a first value measured through a connection between the first antenna and the GPS satellite, (ii) calculating a second value measured through a connection between the second antenna and the GPS satellite, and (iii) determining a correction value to compensate for local conditions by analyzing differences between the first value and the second value.

The objects, features and advantages of the present invention include providing an automotive GNSS real time kinematic dead reckoning receiver that may (i) be used in a vehicle, (ii) provide a more precise GNSS position solution than using current GNSS and vehicle based sensors, (iii) implement a dual RTK type GPS receiver, (iv) transmit to an automotive CAN bus and/or an electronic network, (v) improve position data accuracy by subtracting out effects of noise and ionospheric errors, and/or (vi) combine with dead reckoning to provide a more precise GNSS position solution.

### BRIEF DESCRIPTION OF THE DRAWINGS

These and other objects, features and advantages of the present invention will be apparent from the following detailed description and the appended claims and drawings in which:

FIG. 1 is a diagram illustrating a context of the present invention;

FIG. 2 is a diagram illustrating a more detailed context of the present invention;

FIG. 3 is a diagram of a module;

FIG. 4 is a flow diagram illustrating an operation of a calculation portion of the module;

FIG. 5 is a flow diagram illustrating an operation of a correction portion of the module; and

FIG. 6 is a flow diagram illustrating an operation of a parent and child functionality of the module.

### DETAILED DESCRIPTION OF THE PREFERRED EMBODIMENTS

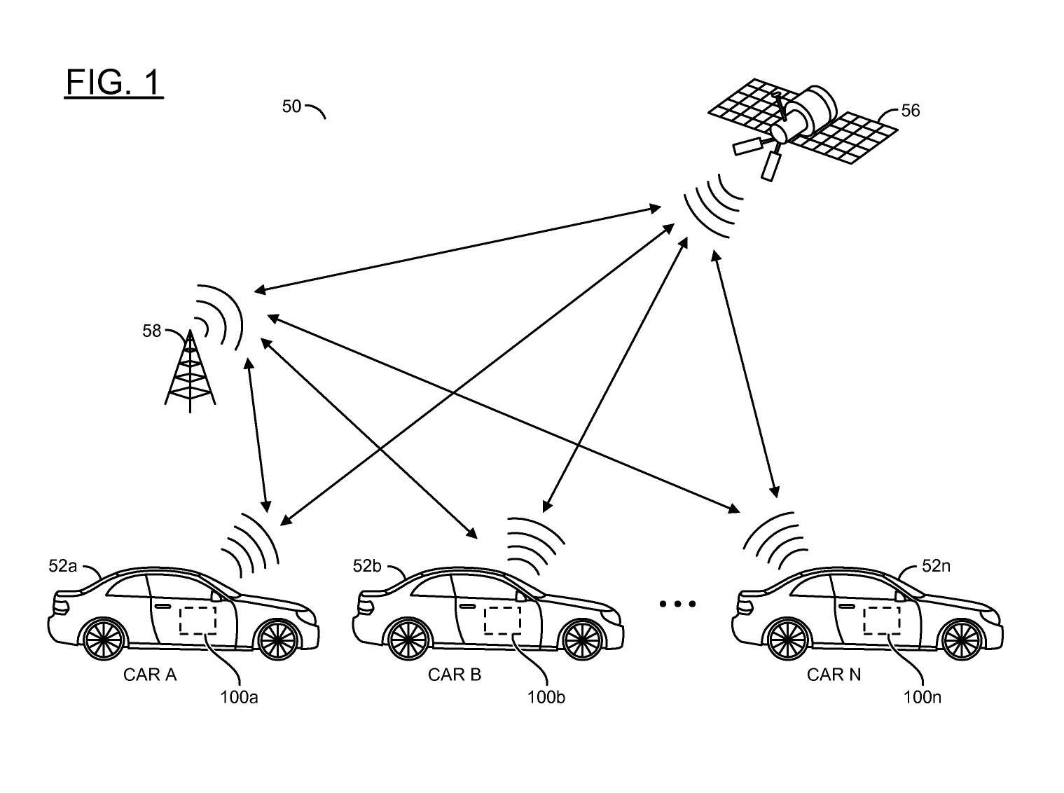

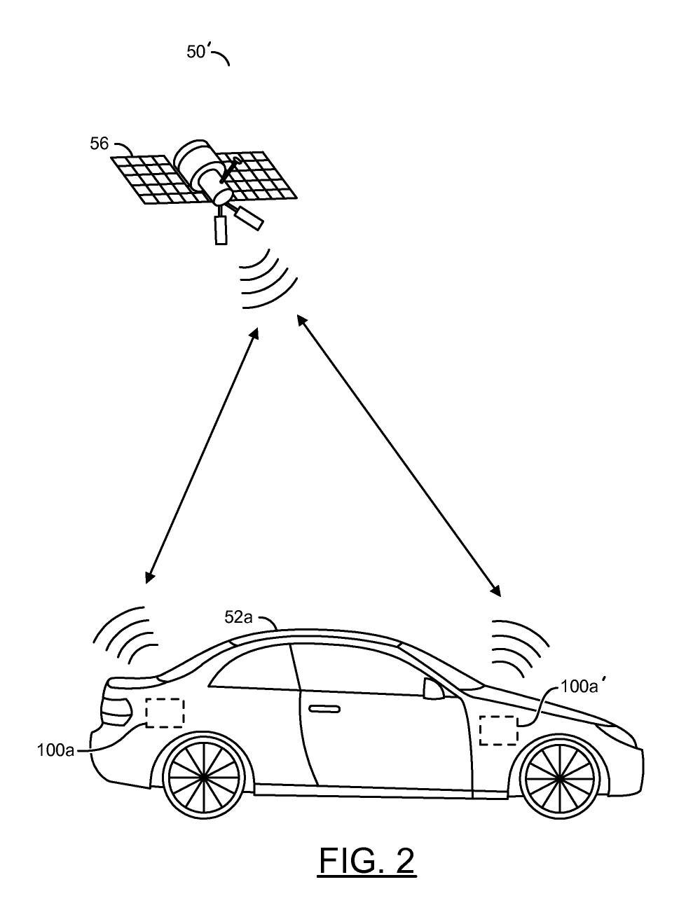

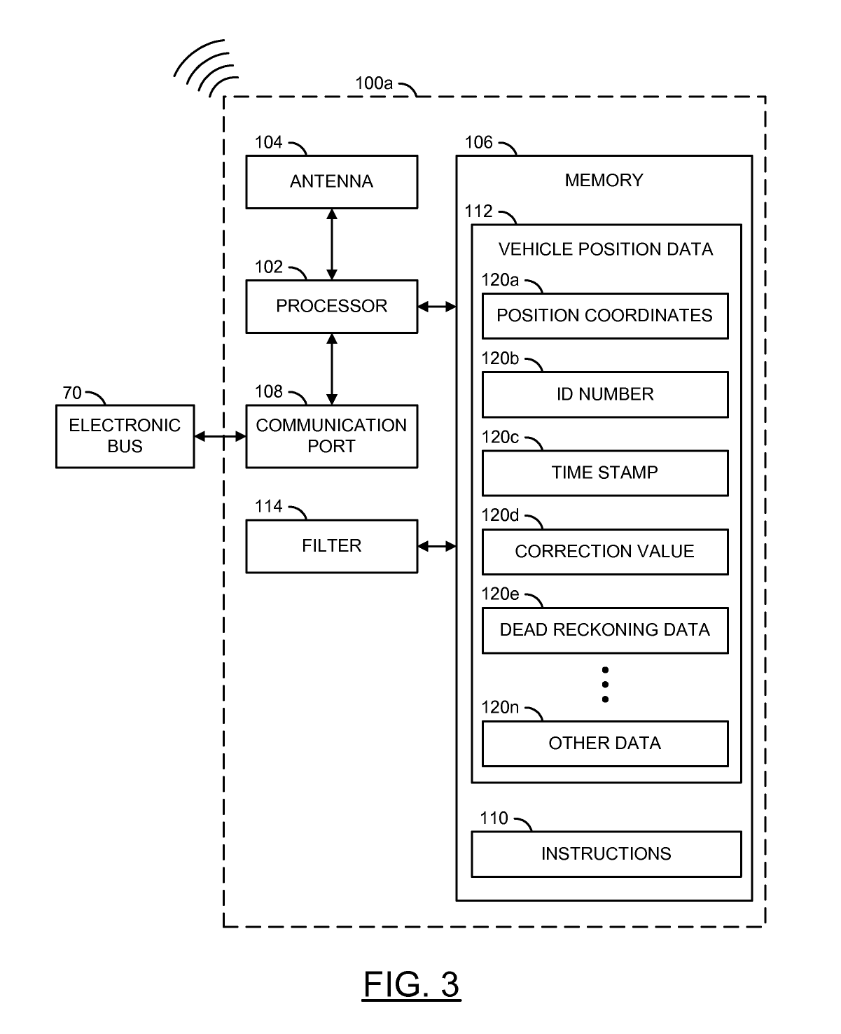

Referring to FIG. 1, a diagram of a system 50 is shown in accordance with an embodiment of the invention. The system 50 generally comprises a number of vehicles 52a-52n, a satellite 56, and a base station 58. Each of the vehicles 52a-52n comprise at least two of a number of apparatus (or modules or circuits) 100a-100n (the system 50 is shows the vehicles 52a-52n having one of the apparatus 100a-100n for clarity). The arrangement of the two or more modules 100a-100n in each of the vehicles 52a-52n is described in more detail in connection with FIG. 2. The module 100a is described in more detail in connection with FIG. 3.

Each of the vehicles 52a-52n are shown connected to the satellite 56. For example, each of the modules 100a-100n in the vehicles 52a-52n may connect to the satellite 56. The connection to the satellite 56 may be implemented through a GPS-type connection. Connecting at least two of the modules 100a-100n in each of the vehicles 52a-52n may allow the modules 100a-100n to calculate a correction value for a GNSS position solution.

Each of the vehicles 52a-52n may also be configured to connect to the base station 58. In general, the base station 58 may be implemented as a fixed based station, such as a cellular tower, a user installed fixed base station, or another type of fixed base station. The connection to the base station 58 may be implemented through a cellular network connection (e.g., 3G, 4G LTE, etc.), a Wi-Fi connection, a GPS-type connection and/or another type of connection. The type of connection to the base station 58 may be varied according to the design criteria of a particular implementation.

For example, the modules 100a of the vehicle 52a may receive a correction value and/or position data from the base station 58. If the base station 58 is not within a usable range of the modules 100a (e.g., the base station is beyond a distance of 25 km, the correction value does not pass a quality and/or reliability check, etc.), a correction value may be calculated using another one of the modules 100a-100n in the vehicle 52a.

The modules 100a-100n are shown located in the respective vehicles 52a-52n. The modules 100a-100n may be implemented as a single unit (e.g., an installed device and/or module) and/or a distributed unit. For example, various components of the modules 100a-100n may be implemented at various locations in and/or on the vehicles 52a-52n and connected by an electronic network connecting one or more of the components enabling a sharing of information in the form of digital signals (e.g., a serial bus, an electronic bus connected by wiring and/or interfaces, a wireless interface, etc.). In some embodiments, the modules 100a-100n may be implemented in an infotainment module of the vehicles 100a-100n. The location of the modules 100a-100n in and/or on the vehicles 52a-52n may be varied according to the design criteria of a particular implementation.

Referring to FIG. 2, a diagram of a system 50′ is shown in accordance with an embodiment of the invention. The system 50′ shows a more detailed view of the vehicle 52a. The vehicle 52a is shown comprising the module 100a and the module 100a′. The module 100a and/or 100a′ may be similar to the module 100a-100n. A number of the modules 100a-100n implemented in the vehicle 52a may be varied according to the design criteria of a particular implementation.

The module 100a is shown at a rear end of the vehicle 52a. The module 100a′ is shown at a front end of the vehicle 52a. The location of the modules 100a-100n in the vehicle 52a may be varied according to the design criteria of a particular implementation. Generally, the module 100a and the module 100a′ (or antennas of the modules 100a and 100a′) are separated by several meters. For example, the antennas of the modules 100a and 100a′ may be separated by at least 1 meter. The modules 100a and 100a′ are shown separated far enough to provide a different angle of connection to the satellite 56. The different angle and/or distance between the modules 100a and 100a′ may allow the satellite 56 to provide different GNSS data to the modules 100a and 100a′ for the vehicle 52a.

The modules 100a and/or 100a′ may implement dual RTK type GPS receivers. With the modules 100a and 100a′ separated by several meters, the accuracy of GNSS data may be improved. For example, the GNSS data received by the modules 100a and 100a′ may be used for subtracting out effects of noise and/or ionospheric errors from the positioning solution (e.g., applying the correction value). The corrected positioning solution may be combined with dead reckoning information. In one example, the dead reckoning may be performed by the modules 100a and/or 100a′. In another example, the modules 100a and/or 100a′ may be configured to transmit the corrected positioning solution to an electronic network (e.g., an automotive CAN bus). The modules 100a and/or 100a′ may be configured to connect to additional ground based RTK GPS solutions (e.g., the base station 58).

In some embodiments, the modules 100a and 100a′ may be configured to have a parent-child (e.g., master-slave) relationship. For example, the module 100a may be the parent module and the module 100a′ may be the child module. The parent module 100a may be configured to provide more functionality than the child module 100a′. For example, the child module 100a′ may be configured to communicate with the satellite 56 and communicate the received GNSS data to the parent module 100a. The parent module 100a may be configured to communicate with the satellite 56, receive the GNSS data from the satellite 56 and/or the child module 100a′.

The parent module 100a may use the GNSS data from the child module 100a′ as the correction value for the GNSS data received from the satellite 56. In some embodiments, the parent module 100a may be implemented with greater functionality and/or more components. For example, the parent module 100a may have more memory than the child module 100a′ and/or the parent module 100a may be implemented with a processor having more processing power than the child module 100a′. Generally, the modules 100a and 100a′ are at least implemented having an antenna. For example, the parent module 100a may provide full functionality (e.g., a memory and a processor configured to determine a correction value, etc.) and the child module 100a′ may be implemented as an antenna).

In some embodiments, the modules 100a and 100a′ may alternate between parent module functionality and child module functionality. For example, the modules 100a and 100a′ may be implemented with similar functionality and/or similar components to be able to switch between child functionality and parent functionality. In one example, the module 100a may be in a parent mode and perform calculations while the module 100a′ is in a child mode to communicate with the satellite 56. Continuing the example, the module 100a may then switch to the child mode to communicate with the satellite 56 while the module 100a′ enters the parent mode to perform the calculations.

Alternating between types of functionality may reduce an amount of time spent processing and/or an amount of power consumed by each of the modules 100a and 100a′. In another embodiment, the modules 100a and/or 100a′ may alternate functionality based on a movement of the vehicle 52a. For example, the module 100a may be configured to perform calculations while the vehicle 52a is in motion, and communicate with the satellite 56 while the vehicle 52a is stationary, while the module 100a′ may be configured to operate in an opposite manner.

Referring to FIG. 3, a diagram of the module 100a (or 100a′) is shown. The apparatus 100a generally comprises a block (or circuit) 102, a block (or circuit) 104, a block (or circuit) 106 and/or a block (or circuit) 108. The circuit 102 may implement a processor. The circuit 104 may implement an antenna. The circuit 106 may implement a memory. The circuit 108 may implement a communication port. Other blocks (or circuits) may be implemented (e.g., a clock circuit, I/O ports, power connectors, etc.). For example, a block (or circuit) 114 is shown implementing a filter. The module 100a′ generally comprises similar components. In some embodiments, the module 100a′ may comprise a subset of the components shown.

The processor 102 may be configured to execute stored computer readable instructions (e.g., instructions 110 stored in the memory 106). The processor 102 may perform one or more steps based on the stored instructions 110. For example, one of the steps executed/performed by the processor 102 may calculate a value (e.g., a correction value and/or position data) measured through a connection between the antenna 104 and the GPS satellite 56. In another example, one of the steps executed/performed by the processor 102 may calculate a value (e.g., a correction value and/or position data) measured through a connection between the antenna 104 of the other module 100a′ and the GPS satellite 56. In yet another example, one of the steps executed/performed by the processor 102 may determine a correction value to compensate for local conditions by analyzing differences between the values measured by the module 100a and the module 100a′. The instructions executed and/or the order of the instructions performed by the processor 102 may be varied according to the design criteria of a particular implementation. The processor 102 is shown sending data to and/or receiving data from the antenna 104, the memory 106 and/or the communication port 108.

The processor 102 may be implemented as a microcontroller and/or a GPS chipset. In some embodiments, the processor may be a combined (e.g., integrated) chipset implementing processing functionality and the GPS chipset. In some embodiments, the processor 102 may be comprised of two separate circuits (e.g., the microcontroller and the GPS chipset). The design of the processor 102 and/or the functionality of various components of the processor 102 may be varied according to the design criteria of a particular implementation.

The antenna 104 may be implemented as a dual band antenna capable of connecting to both a cellular network (e.g., to provide a potential connection option to the base station 58) and/or a GPS network (e.g., the satellite 56). In another example, the antenna 104 may be implemented as two antennas. For example, one antenna may be specifically designed to connect to the base station 58, while another antenna may be implemented as being optimized to connect to the GPS network 56. The antenna 104 may be implemented as discrete antenna modules and/or a dual band antenna module.

The memory 106 may comprise a block (or circuit) 110 and a block (or circuit) 112. The block 110 may store the computer readable instructions (e.g., the instructions readable by the processor 102). The block 112 may store vehicle position data. For example, the vehicle position data 112 may store various data sets 120a-120n. Examples of the data sets may be position coordinates 120a, an ID number 120b, a time stamp 120c, a correction value 120d, dead reckoning data 120e and/or other data 120n.

The position coordinates 120a may store position data retrieved by the module 100a from the GPS satellite 56. The GPS satellite 56 may provide a particular resolution of position data accuracy. In some embodiments, the position coordinates 120a may not provide sufficient accuracy for particular applications (e.g., lane detection, autonomous driving, etc.). The correction value 120d may be used to improve the accuracy of the position coordinates 120a. In some embodiments, the position coordinates 120a may be calculated by the filter 114.

The ID number 120b may be used to determine an identity of the vehicles 52a-52n and/or each of the modules 100a-100n in each of the vehicles 52a-52n (e.g., an identity of the module 100a and an identity of the module 100a′ in the vehicle 52a). The ID number 120b may provide an identification system for each of the vehicles 52a-52n and/or each of the modules 100a-100n. For example, the ID number 120b may allow each of the modules 100a-100n know which module to communicate to/from.

The time stamp 120c may be used to determine an age of the vehicle position data 112. For example, the time stamp 120c may be used to determine if the vehicle position data 112 should be considered reliable or unreliable. The time stamp 120c may be updated when the modules 100a-100n update the vehicle position data 112. For example, the time stamp 120c may record a time in Coordinated Universal Time (UTC) and/or in a local time. The implementation of the time stamp 120c may be varied according to the design criteria of a particular implementation.

The correction value 120d may be used to augment (e.g., improve) a precision of the position coordinates 120a. The correction data 120d may implement real-time accuracy correction for the position coordinates 120a. The correction data 120d may be used to account (e.g., compensate) for location conditions that may affect an accuracy of the position coordinates 120a. In one example, the correction value 120d for the module 100a may be provided by the module 100a′. In another example, the module 100a′ may provide additional position coordinates 120a and the processor 102 of the module 100a may calculate the correction value 120d based on the position coordinates 120a calculated by the module 100a and the position coordinates 120a calculated by the module 100a′. In some embodiments, the correction value 120d may be received from the base station 58.

The dead reckoning data 120e may be used to store past and/or present information to determine a location traveled by the vehicle 52a. For example, the dead reckoning data 120e may store a previously determined position of the vehicle 52a (e.g., estimated speed, estimated time of travel, estimated location, etc.). The previously determined position may be used to help determine a current position of the vehicle 52a. In some embodiments, the dead reckoning data 120e may be determined based on data from sensors of the vehicle 52a (e.g., an on-board gyroscope and/or wheel click messages). The implementation and/or the information stored to determine the dead reckoning data 120e may be varied according to the design criteria of a particular implementation.

The communication port 108 may allow the module 100a to communicate with external devices and/or the modules (e.g., the module 100a′). For example, the module 100a is shown connected to an external electronic bus 70. In some embodiments, the electronic bus 70 may be implemented as a vehicle CAN bus. The electronic bus 70 may be implemented as an electronic wired network and/or a wireless network. Generally, the electronic bus 70 may connect one or more component of the vehicle 52a enabling a sharing of information in the form of digital signals (e.g., a serial bus, an electronic bus connected by wiring and/or interfaces, a wireless interface, etc.).

The communication port 108 may allow the module 100a to share the vehicle position data 112 with various infrastructure of the vehicle 52a. The communication port 108 may allow the module 100a to receive information from the sensors of the vehicle 52a (e.g., the on-board gyroscope data and/or wheel click messages used to determine the dead reckoning data 120e). The communication port 108 may allow the module 100a to communicate with the module 100a′ to determine multiple GNSS data values and/or determine the correction value 120d. For example, information from the module 100a may be communicated to an infotainment device for display to a driver. In another example, a wireless connection (e.g., Wi-Fi, Bluetooth, cellular, etc.) to a portable computing device (e.g., a smartphone, a tablet computer, a notebook computer, a smart watch, etc.) may allow information from the module 100a to be displayed to a user.

Each of the modules 100a-100n may be configured to calculate a position and/or broadcast data (e.g., via the communication port 108) such as the positional coordinates 120a, the ID number 120b, an age of the data (e.g., when the data was last updated such as the time stamp 120c), the correction value 120d and/or other data 120n. A method of communication by the communication port 108 and/or the type of data transmitted may be varied according to the design criteria of a particular implementation.

The filter 114 may be configured to perform a linear quadratic estimation. For example, the filter 114 may implement a Kalman filter. Generally, the filter 114 may operate recursively on input data to produce a statistically optimal estimate. For example, the filter 114 may be used to calculate the position coordinates 120a and/or estimate the accuracy of the position coordinates 120a. In some embodiments, the filter 114 may be implemented as a separate module. In some embodiments, the filter 114 may be implemented as part of the memory 106 (e.g., the stored instructions 110). The implementation of the filter 114 may be varied according to the design criteria of a particular implementation.

The local conditions may be any type of interference and/or factor that may affect a determination of the position coordinates 120a. The local conditions may reduce a reliability of the position coordinates 120a. For example, the local conditions may be due to ionospheric interference, noise, signal degradation caused by dense urban areas, signal degradation caused by tall buildings, etc. The type and/or cause of the local conditions may be varied according to the design criteria of a particular implementation.

In some embodiments, the module 100a and the module 100a′ (or the antennas 104 of the module 100a and the module 100a′) may be placed approximately 1 meter apart. The modules 100a and 100a′ may share data (e.g., the vehicle position data 112) via the electronic bus 70. The module 100a and/or the module 100a′ may determine the correction value 120d. In one example, the module 100a and/or the module 100a′ may receive the correction value 120d from a ground based system such as the base station 58. In another example, the module 100a and/or the module 100a′ may calculate one or more of the correction values 120d. The corrected value 120d may be applied to determine a more accurate GNSS position solution. Implementing the two modules 100a and 100a′ may allow a determination of the GNSS position solution to be autonomous within the vehicle 52a. For example, no other communications outside the vehicle 52a may be needed to improve the accuracy of the GNSS position solution over the position solution determined by a conventional single GPS receiver.

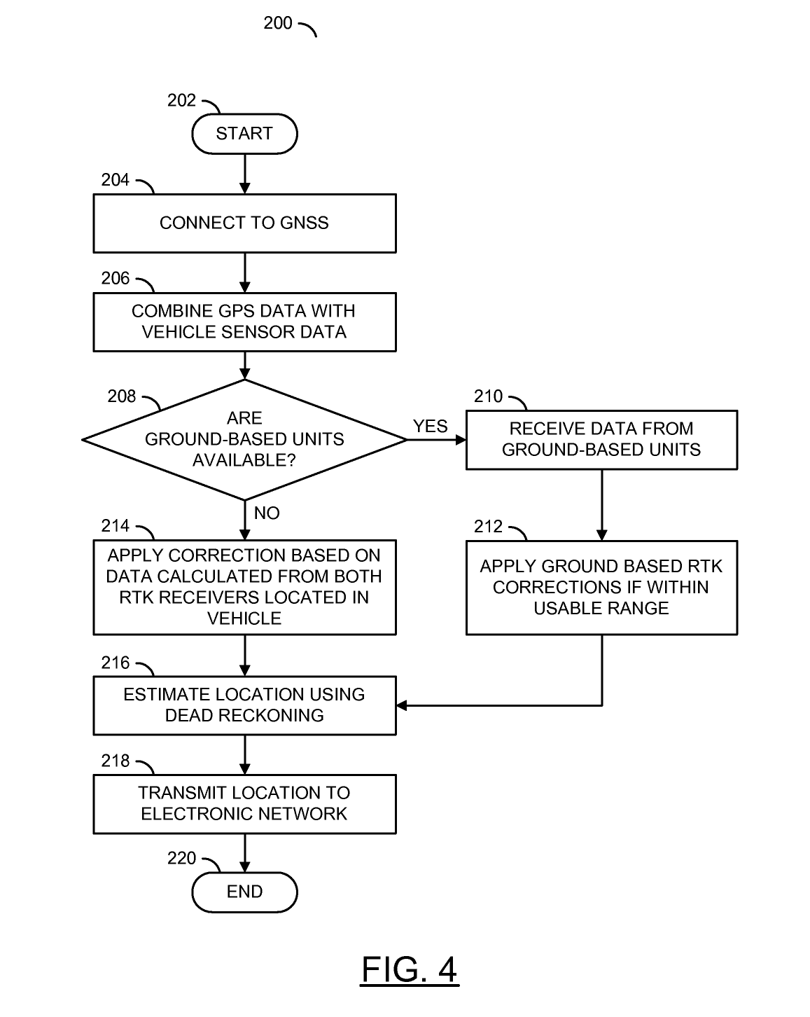

Referring to FIG. 4, a method (or process) 200 is shown. The method 200 may be an operation of a calculation portion of the module 100a (or 100a′). The method 200 generally comprises a step (or state) 202, a step (or state) 204, a step (or state) 206, a decision step (or state) 208, a step (or state) 210, a step (or state) 212, a step (or state) 214, a step (or state) 216, a step (or state) 218, and a step (or state) 220.

The state 202 may be a start state for the method 200. Next, the state 204 may connect to the GNSS (e.g., the GPS satellite 56). The state 206 may combine GPS data (e.g., the position coordinates 120a) from the satellite 56 with sensor data from the vehicle 52a (e.g., the on-board gyroscope data and/or the wheel click messages). Next, the method 200 may move to the decision state 208.

The decision state 208 may determine whether there are ground-based units (e.g., such as the base station 58) available. If so, the method 200 may move to the state 210. If not, the method 200 may move to the state 214. The state 210 may receive data (e.g., the position data 120a and/or the correction value 120d) from the ground-based units 58. Next, the state 212 may apply ground-based RTK corrections if the base station 58 is within the usable range. Next, the method 200 may move to the state 216.

The state 214 may apply the correction value 120d based on data calculated from both RTK receivers (e.g., the modules 100a and 100a′) located in the vehicle 52a. Next, the method 200 may move to the state 216. The state 216 may estimate the location of the vehicle 52a using dead reckoning (e.g., based on the dead reckoning data 120e). The state 218 may transmit the location of the vehicle 52a to the electronic network/bus 70. Next, the method 200 may end at the state 220.

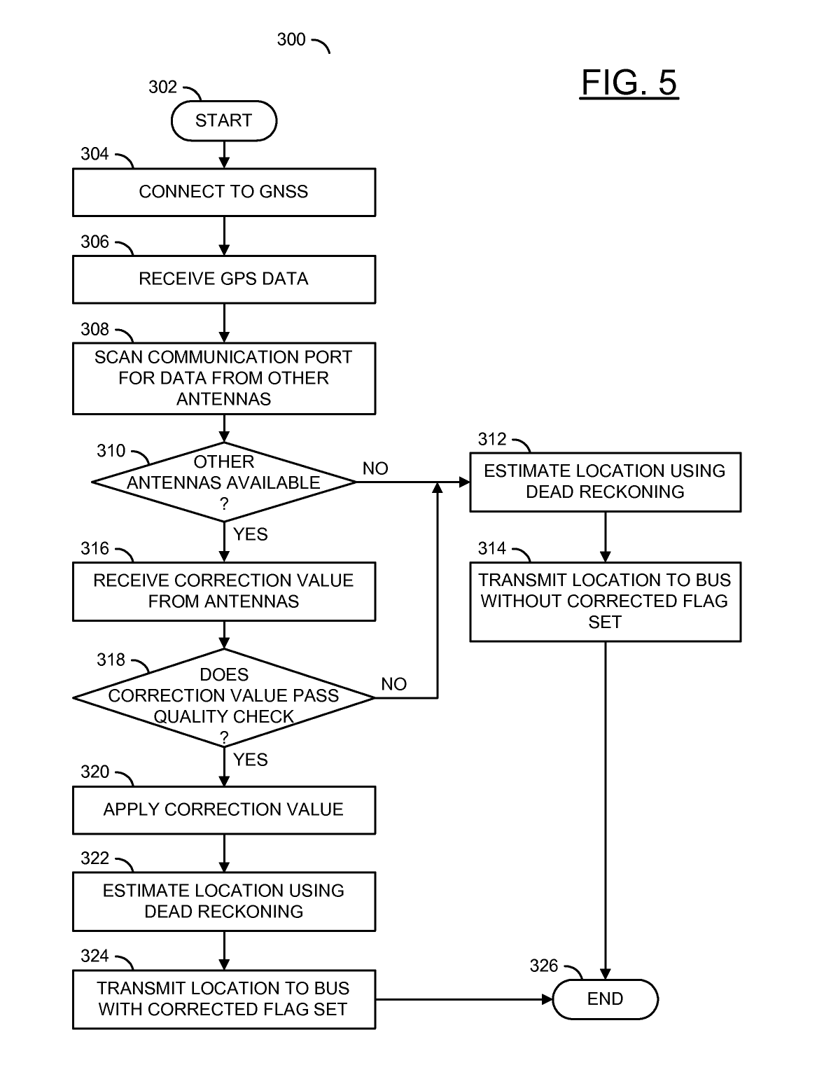

Referring to FIG. 5, a method (or process) 300 is shown. The method 300 may be an operation of a correction portion of the module 100a (or 100a′). The method 300 generally comprises a step (or state) 302, a step (or state) 304, a step (or state) 306, a step (or state) 308, a decision step (or state) 310, a step (or state) 312, a step (or state) 314, a step (or state) 316, a decision step (or state) 318, a step (or state) 320, a step (or state) 322, a step (or state) 324 and a step (or state) 326.

The state 302 may start the method 300. The state 304 may connect to the GNSS (e.g., the GPS satellite 56). Next, in the state 306, the module 100a may receive the GPS data (e.g., the position coordinates 120a) from the satellite 56. In the state 308, the module 100a may scan the communication port 108 for data from other antennas (e.g., the antenna 104 of the module 100a′). Next, the method 300 may move to the decision state 310.

The decision state 310 may determine whether other antennas are available. If not, the method 300 may move to the state 312. If so, the method 300 may move to the state 316. The state 312 may estimate a location of the vehicle 52a using dead reckoning (e.g., based on the dead reckoning data 120e). Next, the state 314 may transmit the location of the vehicle 52a to the electronic bus 70 without setting a corrected flag. Next, the method 300 may move to the state 326.

The state 316 may receive the correction value 120d from the other antennas (e.g., the antenna 104 of the module 100a′). Next, the decision state 318 may determine whether the correction value 120d passes a quality check. If not, the method 300 may move to the state 312. If so, the method 300 may move to the state 320. The state 320 may apply the correction value 120d (e.g., subtract the correction value 120d from the position coordinates 120a). Next, the state 322 may estimate a location of the vehicle 52a using dead reckoning (e.g., based on the dead reckoning data 120e and/or the position coordinates 120a corrected by the correction value 120d)). The state 324 may transmit the location of the vehicle 52a to the electronic bus 70 with the corrected flag set. Next, the method 300 may move to the state 326. The state 326 may end the method 300.

The corrected flag may be implemented (e.g., appended to data sent by the modules 100a and/or 100a′ to the electronic bus 70) to indicate whether or not the GPS data has been corrected. The corrected flag may be implemented as an indicator (e.g., a logical high bit, a logical low bit, an instruction, a signal, etc.). The corrected flag may indicate whether the position coordinates 120a have been corrected using the correction value 120d. In one example, if the corrected flag is set, other components using the position coordinates 120a communicated by the module 100a and/or 100a′ may assume that the position coordinates 120a have an improved accuracy (e.g., the correction value 120d has been applied). In another example, if the corrected flag is not set, other components using the position coordinates 120a communicated by the module 100a and/or 100a′ may assume that the position coordinates 120a do not have an improved accuracy (e.g., the correction value 120d has not been applied). In some embodiments, the corrected flag may be set when the correction value 120d is received from the base station 58 and the corrected flag may not be set when the corrected value 120d is calculated by the modules 100a-100n. In some embodiments, there may be more than one type of corrected flag. For example, one corrected flag may be set when the corrected value 120d is received from the base station 58 and another type of corrected flag may be set when the corrected value 120d is calculated by the modules 100a-100n.

In some embodiments, particular features may depend on a state of the corrected flag and features may be disabled when the corrected flag is not set. For example, autonomous driving may not be available when the corrected value is not set. In some embodiments, when the corrected flag is not set, the modules 100a-100n may continue to use the GPS data (e.g., the position coordinates 120a retrieved from the satellite 56). However, the modules 100a-100n may prevent (e.g., shut down, disable, etc.) some functionality (e.g., of the vehicles 52a-52n) related to position accuracy when the corrected value is not set. The implementation of the corrected flag may be varied according to the design criteria of a particular implementation.

The quality check may determine whether or not the correction value 120d may be relied upon. In some embodiments, the quality check for the correction value 120d may be based on the vehicle position data 112 provided by the modules 100a and/or 100a′. In some embodiments, the module 100a may connect to the fixed base station 58. Position data received from the fixed base station 58 may be assumed to be correct (e.g., passes the quality check). In some embodiments, the module 100a may check the vehicle position data 112 (e.g., perform the quality check) from the other module 100a′. For example, the quality check may be based on a minimum allowed noise and/or interference when connecting to the satellite 56. In another example, the quality check may be based on the time stamp 120c of the data received from the modules 100a and 100a′. If the time stamp 120c is older than a pre-determined threshold, the correction data 120d may be too old (e.g., considered unreliable) for use. The types of data checked and/or the thresholds used to determine whether the data passes the quality check may be varied according to the design criteria of a particular implementation.

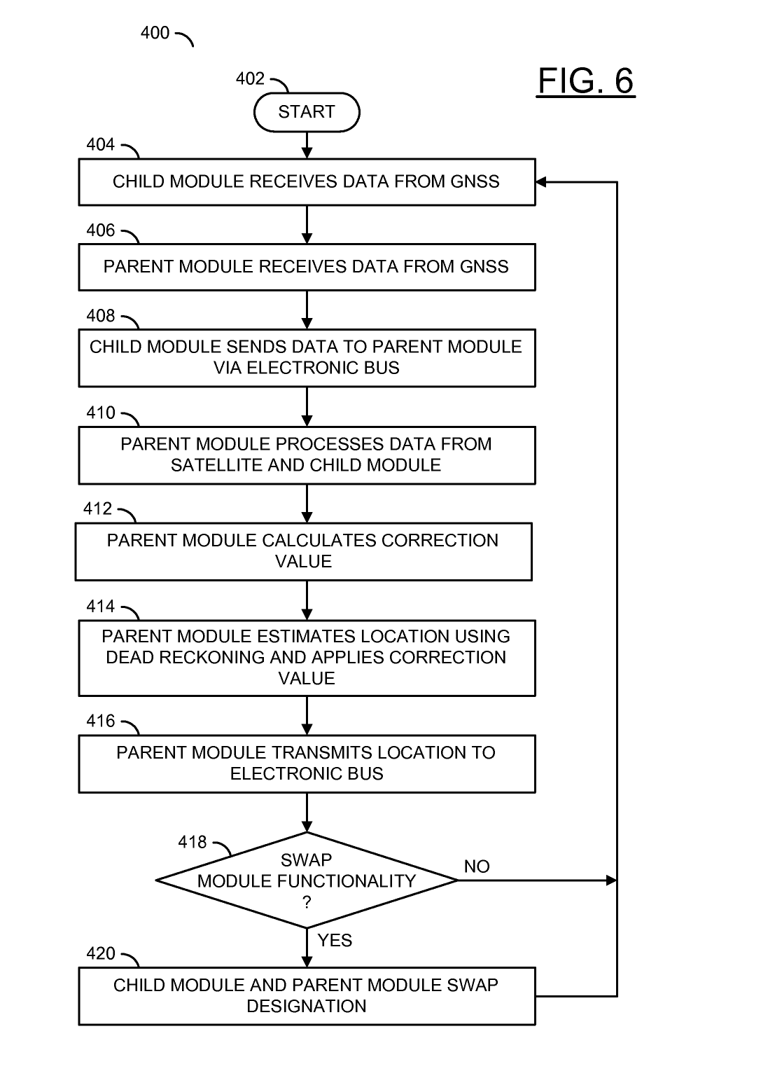

Referring to FIG. 6, a method (or process) 400 is shown. The method 400 may be an operation of a parent and child functionality of the module 100a (or 100a′). The method 400 generally comprises a step (or state) 402, a step (or state) 404, a step (or state) 406, a step (or state) 408, a step (or state) 410, a step (or state) 412, a step (or state) 414, a step (or state) 416, a decision step (or state) 418, and a step (or state) 420.

The state 402 may start the method 400. In the state 404, the child module 100a′ may receive data from the GNSS (e.g., the satellite 56). In the state 406, the parent module 100a may receive data from the GNSS (e.g., the satellite 56). Next, in the state 408, the child module 100a′ may send data to the parent module 100a via the electronic bus 70. In the state 410, the parent module 100a may process the data from the satellite 56 and/or the child module 100a′. Next, in the state 412, the parent module 100a may calculate the correction value 120d.

In the state 414, the parent module 100a may estimate the location of the vehicle 52a using dead reckoning (e.g., based on the dead reckoning data 120e) and apply the correction value 120d. In the state 416, the parent module 100a may transmit the determined location of the vehicle 52a to the electronic bus 70. Next, the method 400 may move to the decision state 418. The decision state 418 may determine whether the modules 100a and 100a′ should swap functionality. If not, the method 400 may return to the state 404. If so, the method 400 may move to the state 420. In the state 420, the child module 100a′ and the parent module 100a may swap designation (e.g., the parent module 100a becomes designated as and/or performs the functionality of the child module 100a′ and the child module 100a′ becomes designated as and/or performs the functionality of the parent module 100a).

In some embodiments, the parent module 100a and the child module 100a′ may swap functionality (e.g., change designation) based on observed local conditions. In one example, when the child module 100a′ has a better view of the sky (e.g., less interference and/or noise when connecting to the satellite 56) than the parent module 100a, the modules 100a and 100a′ may swap functionality. For example, the filter 114 may be used to calculate the position coordinates 120a and/or estimate the accuracy of the position coordinates 120a received by each of the modules 100a and 100a′ to determine which of the modules 100a and 100a′ has a better connection to the satellite 56. The method for determining which of the modules 100a and/or 100a′ has a better connection and/or when to swap designation (e.g., functionality) may be varied according to the design criteria of a particular implementation.

The modules 100a-100n may be configured to calculate position data (e.g., a position of the respective vehicles 52a-52n). The calculation of the position data may be based on the position coordinates 120a and/or the correction value 120d. The processor 102 may be configured to perform calculations to determine the position data. For example, the antenna 104 may be configured to connect to more than one GPS satellite. In another example, the modules 100a-100n may implement separate antennas to connect to multiple GPS satellites. The antenna 104 may receive data from the GPS satellites and a calculation may be performed to determine the position coordinates 120a. Interference due to the local conditions may be estimated. The correction value 120d may be used to cancel out the estimated interference due to the local conditions.

The modules 100a-100n may be used to enhance the precision of position data for a GPS/GNSS satellite based system. The modules 100a-100n may be configured to use a phase and carrier wave from a fixed reference device (e.g., the base station 58) and/or a second module (e.g., the module 100a′) to provide real-time corrections and/or enhancements to determine the position solution.

The modules 100a-100n may be implemented to publish the vehicle position data 112 to the electronic bus 70. For example, the vehicle position data 112 may be made available to multiple components such as navigation and/or automatic emergency services. The vehicle position data 112 may comprise latitude, longitude and height, speed over ground information, time information, and/or a heading. For example, the vehicle position data 112 may be transmitted when an emergency call (e.g., eCall) is triggered (e.g., due to an impact detection and/or airbag deployment). In another example, the vehicle position data 112 may be converted to a compass bearing and published to the electronic bus 70. A compass bearing and/or location based information may be displayed to an infotainment module and/or a user device.

The modules 100a-100n may combine an RTK system designed to work in an automotive environment. The modules 100a-100n may provide a more accurate solution to an automotive network. The position solution determined by the modules 100a-100n may be autonomous.

The functions performed by the diagrams of FIGS. 4-6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a first antenna configured to connect to a GPS satellite;
a second antenna configured to connect to said GPS satellite, wherein said first antenna is positioned separately from said second antenna;
a processor configured to execute instructions; and
a memory configured to store said instructions that, when executed, perform the steps of (i) calculating a first value measured through a connection between said first antenna and said GPS satellite, (ii) calculating a second value measured through a connection between said second antenna and said GPS satellite, and (iii) determining a correction value to compensate for local conditions by analyzing differences between said first value and said second value.

2. The apparatus according to claim 1, wherein said first antenna is positioned at least one meter from said second antenna.

3. The apparatus according to claim 1, further comprising a communication port configured to communicate with a serial bus.

4. The apparatus according to claim 3, wherein said serial bus is configured as a vehicle controller area network (CAN) bus.

5. The apparatus according to claim 3, wherein said communication port transmits said correction value to said serial bus.

6. The apparatus according to claim 1, wherein said correction value is combined with dead reckoning data.

7. The apparatus according to claim 6, wherein said dead reckoning data is determined based on data from vehicle sensors.

8. The apparatus according to claim 7, wherein said data from said vehicle sensors comprise at least one of an on-board gyroscope data and wheel click messages.

9. The apparatus according to claim 1, wherein said local conditions comprise at least one of noise and ionospheric interference.

10. The apparatus according to claim 1, wherein (i) said apparatus is further configured to retrieve data from a ground based unit and (ii) said correction value is further determined based on said data from said ground based unit.

11. The apparatus according to claim 10, wherein said apparatus is configured to use said correction value determined based on said first value and said second value, if said apparatus is unable to retrieve said data from said ground based unit.

12. The apparatus according to claim 10, wherein said apparatus is configured to retrieve said data from said ground based unit using a cellular connection.

13. The apparatus according to claim 1, wherein said correction value is an improvement to GPS data received from said GPS satellite.

14. The apparatus according to claim 1, wherein said memory is further configured to determine whether said correction value passes a quality check.

15. The apparatus according to claim 1, wherein said apparatus implements an automotive Global Navigation Satellite System real time kinematic dead reckoning receiver.

16. The apparatus according to claim 1, wherein (i) a first module implements at least said first antenna, (ii) a second module implements at least said second antenna and (iii) at least one of said first module and said second module implements said processor and said memory.

17. The apparatus according to claim 16, wherein (i) said first module is designated as a parent module, (ii) said second module is designated as a child module, (iii) said child module is configured to (a) receive said second value from said GPS satellite and (b) send said second value to said parent module via an electronic bus and (iv) said parent module is configured to (a) receive said first value from said GPS satellite, (b) receive said second value from said electronic bus, (c) calculate said correction value and (d) transmit said correction value via said electronic bus.

18. The apparatus according to claim 17, wherein said first module and said second module are further configured to swap designation as said parent module and said child module.

19. A method for correcting location data of a vehicle, comprising the steps of:
calculating a first value measured through a connection between a first antenna and a GPS satellite;
calculating a second value measured through a connection between a second antenna and said GPS satellite, wherein said first antenna is positioned separately from said second antenna; and
determining a correction value to compensate for local conditions by analyzing differences between said first value and said second value, wherein said correction value is applied to said location data of said vehicle.
